(19) United States
(12) Patent Application Publication
(10) Pub. No.: US 2023/0060724 A1
(43) Pub. Date: Mar. 2, 2023

(54) HIGH-FLEXIBILITY GRIPPER

(71) Applicant: ATS Automation Tooling Systems Inc., Cambridge (CA)

(72) Inventors: David Mothersbaugh, Cambridge (CA); Maciej Ruchala, Cambridge (CA); Marc Harvala, Cambridge (CA); Blake Garner, Cambridge (CA); Alexander John LaBrash, Cambridge (CA)

(21) Appl. No.: 17/894,846

(22) Filed: Aug. 24, 2022

Related U.S. Application Data
(60) Provisional application No. 63/238,557, filed on Aug. 30, 2021.

(51) Int. Cl. B25J 15/08; B25J 15/10; B25J 13/08; B25J 19/02

(52) U.S. Cl. CPC B25J 15/086; B25J 13/082; B25J 15/103; B25J 19/023

(57) ABSTRACT

A gripper head, including a frame having a plurality of cantilever arms, an upper end, and a lower end opposite the upper end, with a vertical axis extending between the upper end and the lower end. The gripper head includes a plurality of discrete and spaced-apart tracks, each track extending out from the vertical axis and supporting a gripper finger operable to move along the track between a first position and a second position, the second position being farther from the vertical axis than the first position, each track supported by a corresponding cantilever arm of the plurality of cantilever arms. The gripper head also including a plurality of support bars, each support bar extending between two cantilever arms of the plurality of cantilever arms.

### FIELD

The specification relates generally to material handling, and more specifically to grippers.

### BACKGROUND

U.S. Pat. No. 10,464,218 to Golan et al. (“Golan”) purports to disclose a gripper system comprising fingers. The gripper fingers are connectable to a gripper arm. The gripper fingers comprise a roller configured to spin around its central axis or a ball element rotatable in any direction; a stopper configured to stop and/or prevent the spinning of the roller or ball. The present invention also relates to a method for grasping and displacing an object.

U.S. Pat. App. Pub. No. 2015/0251321 to Ishikawa (“Ishikawa”) purports to disclose a robot hand applicable to purpose for holding various types of objects different in size or shape. The robot hand includes a hand base, a first hand arm having a first butting part and a first adsorption part, a second hand arm having a second butting part and a second adsorption part, and a driving mechanism for moving the first and second butting parts in directions to approach each other or separate from each other by moving the first and second hand arms relatively to each other.

U.S. Pat. No. 5,150,937 to Yakou (“Yakou”) purports to disclose a work pickup apparatus with a pickup main body, at least three pickup segments radially movable from substantially a center of the pickup main body, and a driving motor for driving the pickup segments in a synchronous state to pick up a workpiece.

U.S. Pat. App. Pub. No. 2009/0035107 to Duran et al. (“Duran”) purports to disclose a tire rotating robot used to rotate the tires of a vehicle. The robot can remove two tires sequentially without having a human to manually lift the tires. The robot for rotating tires comprises of a mobile base, a body connected to the base, a pivotally mounted two-position rotating beam connected to the body, two arm guide assemblies displaced within a channel of the beam, a motor that powers the robot, and an interface that controls the robot.

### SUMMARY

The following summary is intended to introduce the reader to various aspects of the applicant’s teaching, but not to define any invention.

According to some aspects, there is provided a gripper head, comprising a frame having a plurality of cantilever arms, an upper end, and a lower end opposite the upper end, with a vertical axis extending between the upper end and the lower end; a plurality of discrete and spaced-apart tracks, each track extending out from the vertical axis and supporting a gripper finger operable to move along the track between a first position and a second position, the second position being farther from the vertical axis than the first position, each track supported by a corresponding cantilever arm of the plurality of cantilever arms, and a plurality of support bars, each support bar extending between two cantilever arms of the plurality of cantilever arms.

In any example, it may be that each track includes a first end adjacent the vertical axis and a second end opposite the first end, the second end being farther from the vertical axis than the first end

In any example, it may be that each track extends perpendicular to the vertical axis.

In any example, it may be that the plurality of tracks extend in a common plane.

In any example, it may be that the tracks are equally spaced about the vertical axis.

In any example, it may be that the first and second positions are radially spaced from the vertical axis, and the gripper head is configured as a chuck to hold a load gripped by the gripper fingers.

In any example, it may be that the gripper fingers are operable to be moved synchronistically.

In any example, it may be that the gripper head further comprises a plurality of drive units, wherein each gripper finger is coupled to a corresponding drive unit of the plurality of drive units to be moved by the drive unit.

In any example, it may be that each drive unit is associated with a track of the plurality of tracks, and the drive unit is secured to the frame at the second end of the associated track.

In any example, it may be that each drive unit extends upwards at an angle of at least 45 degrees to the common plane in which each of the plurality of tracks extends.

In any example, it may be that the gripper fingers each extend downward at an angle of at least 45 degrees to the common plane in each of the first and second positions.

In any example, it may be that each track of the plurality of tracks includes a rail and the gripping finger is mounted to the rail to move along the rail.

In any example, it may be that each track of the plurality of tracks is a linear track.

In any example, it may be that each track of the plurality of tracks includes a ball screw.

In any example, it may be that each gripper finger is a force sensing finger.

In any example, it may be that the gripper head further comprises a camera mounted on a support bar of the plurality of support bars.

In any example, it may be that each support bar extends between the two cantilever arms from the second end of the track of a first of the two cantilever arms to the second end of the track of the second of the two cantilever arms.

In any example, it may be that each gripper finger includes a gripping surface.

In any example, it may be that each gripper finger includes a first gripping surface directed towards the vertical axis and a second gripping surface directed away from the vertical axis.

In any example, it may be that the plurality of tracks is three tracks.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a bottom perspective view of a gripper head;

FIG. 2 is a top perspective view of the gripper head of FIG. 1;

FIG. 3 is a cross sectional view of the gripper head of FIG. 1;

FIG. 4 is a cross sectional view of a first portion of the gripper head of FIG. 1;

FIG. 5 is a cross sectional view of a second portion of the gripper head of FIG. 1; and,

FIG. 6 is a bottom view of the gripper head of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or process described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

Although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the examples described herein may be practiced without these specific details. In other instances, well-known methods, procedures, and components have not been described in detail so as not to obscure the examples described herein.

As used herein, the wording “and/or” is intended to represent an inclusive - or. That is, “X and/or Y” is intended to mean X or Y or both, for example. As a further example, “X, Y, and/or Z” is intended to mean X or Y or Z or any combination thereof.

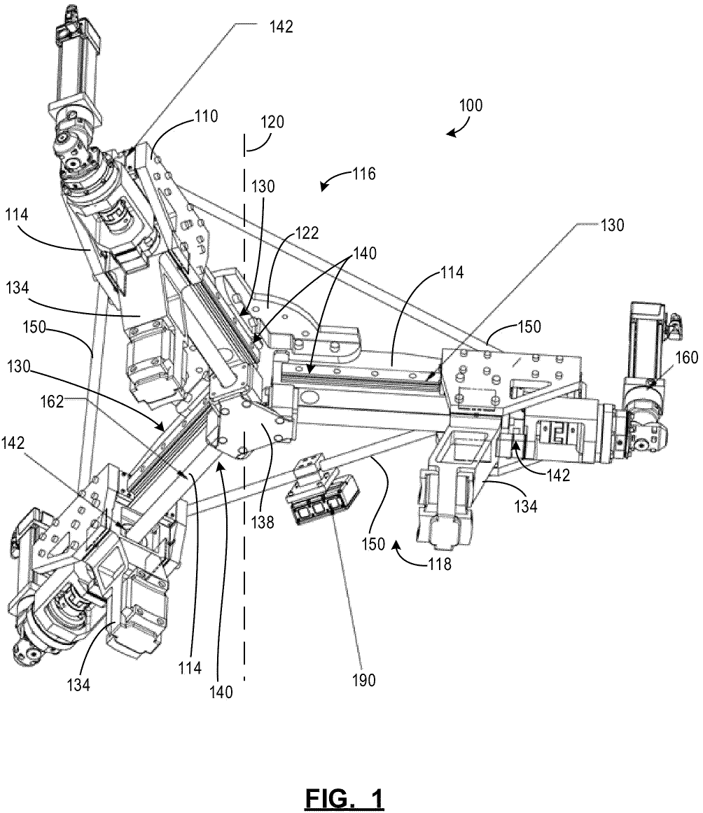

Referring to FIG. 1, illustrated is an exemplary gripper head 100. The gripper head 100 includes a frame 110 having a plurality of cantilever arms 114. The frame 110 also has an upper end 116, and a lower end 118 opposite the upper end 116. A vertical axis 120 extends between the upper end 116 and the lower end 118.

In some examples, the upper end 116 is adapted to be secured to an arm of a robot. The gripper head 100 may be secured to an arm of a robot in any suitable way (e.g., rigidly) such that the arm of the robot may move the gripper head 100 into position over a load to be gripped. In the illustrated example, the upper end 116 includes a coupling plate 122 at which an arm of a robot may be fastened to secure the gripper head to the arm of the robot. The coupling plate 122 is secured to the frame 110 and includes apertures to receive fasteners (e.g., bolts or cords) to hold the gripper head to the arm of the robot.

The lower end 118 is adapted to be directed towards a load to be gripped by the gripper head. The gripper head 100 includes a plurality of discrete and spaced-apart tracks 130 (e.g., three in the illustrated example, though it will be understood that in some examples more or less than three may be used). Each track 130 is secured to the frame 110. Each track 130 extends out from the vertical axis 120. Each track 130 supports a gripper finger 134. Each gripper finger 134 is operable to move along the track 130 between a first position and a second position, the second position being farther from the vertical axis 120 than the first position. Each gripper finger 134 extends from the lower end 118 of the gripper head 100. When the lower end 118 is directed towards a load, the gripper fingers 134 extend out from the gripper head 100 towards the load.

Each track 130 is supported by a corresponding cantilever arm 114. While the tracks 130 may be arranged in various configurations, in some examples the gripper head 100 is configured as a chuck. The gripper fingers 134 are configured to move radially in and out to grip a load that is between or around them (e.g., a load that is adjacent the palm plate 138. In some examples, the first and second positions of the gripper fingers are radially spaced from (i.e., relative to) the vertical axis 120.

In some examples, each track 130 includes a first end 140 adjacent the vertical axis 120 and a second end 142 opposite the first end 140, the second end 142 being farther from the vertical axis 120 than the first end 140. In some examples, each track 130 extends perpendicular to the vertical axis 120 (i.e., the track 130 or a projection of the track 130 intersects the vertical axis 120 at about a 90 degree angle). In some examples, as in the illustrated example, the tracks 130 extend in a common plane. In some examples, as in the illustrated example, the tracks 130 are equally spaced about the vertical axis 120 (i.e., spaced by 120 degrees for three tracks 130, 90 degrees for four tracks 130, etc.). The tracks 130 may be linear tracks.

Each gripper finger 134 is configured to extend out from the lower end 118 in each of the first position and the second position. The gripper fingers 134 may extend past (i.e., beyond) a palm plate 138 of the gripper head to hold a load that is adjacent (e.g., abutting) the palm plate 138. The palm plate 138 is a plate between the gripper fingers 134 bounding an upper end of a gripping area between the gripper fingers 134.

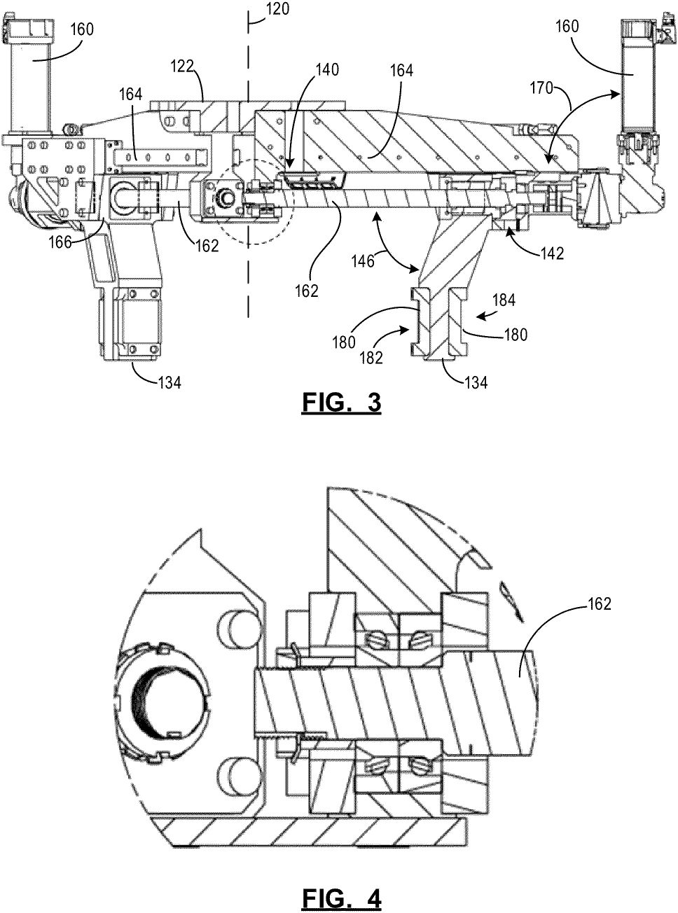

In some examples, the gripper fingers 134 each extend downward at a finger angle 146 (FIG. 3) of at least 30 degrees, at least 45 degrees, or about 90 degrees to the common plane in which each of the tracks 130 extends. The gripper fingers 134 may each extend at the finger angle 146 in each of the first and second positions. Gripper fingers 134 extending downward may be better able to grasp a load.

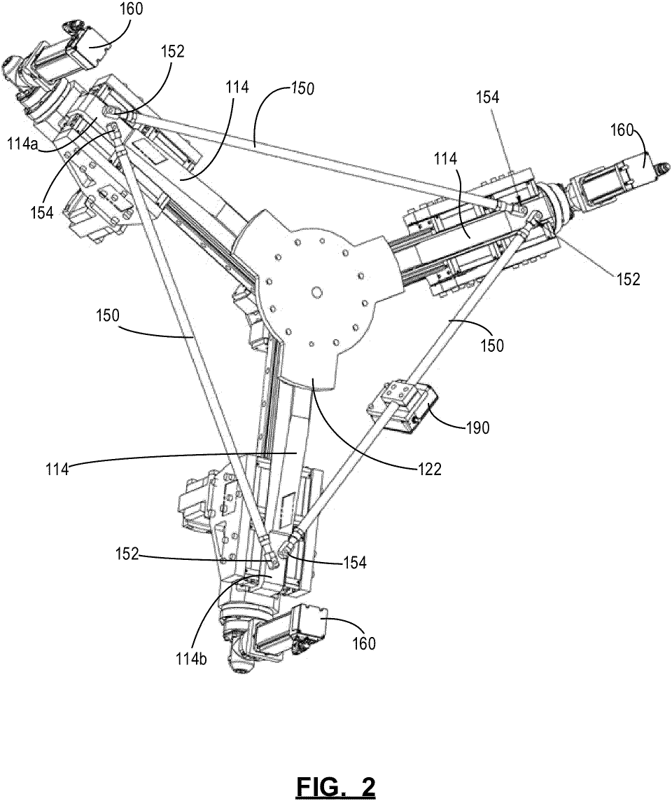

As illustrated in FIG. 2, the gripper head 100 also includes a plurality of support bars 150. Each support bar 150 extends between two cantilever arms 114. Each support bar 150 may extend between the two cantilever arms 114 from the second end 142 of the track 130 of a first 114a of the two cantilever arms 114 to the second end 142 of the track 130 of the second 114b of the two cantilever arms 114.

The support bars 150 provide additional stability to the cantilevered arms 114 and/or provide a mounting point for additional hardware (as discussed further below).

Each support bar 150 is a generally rigid rod. Each support bar 150 is an elongated structure extending from a first end 152 to a second end 154. The first and second ends 152, 154 are secured to the cantilevered arms 114.

In use, the gripper head 100 may be mounted to an arm of a robot. The robot may move the gripper head over a load. The arm may move the gripper head 100 to bring the gripping fingers 134 within an opening of the load if the fingers are in the first position or to position the gripper head 100 with the gripping fingers 134 around the load if the fingers are in the second position. For example, the gripper head 100 may be used to transport a metal plate, and the metal plate may be placed between the gripper fingers 134. In another example, the gripper head 100 may be used to transport a disc with a central aperture, and the gripper fingers 134 may be positioned within the central aperture. The load may be gripped by moving the gripper fingers 134 into engagement with the load. For example, the gripper fingers 134 may be moved in from the second positions to bear against an outer perimeter of the load, or the gripper fingers 134 may be moved out from the first positions to bear against an inner surface of the load that surrounds the central aperture.

The load may be a heavy load. For example, the load may be more than 100 kg, more than 200 kg, more than 250 kg, or about 275 kg. The gripper head 100 may be configured to support the heavy load. For example, the gripper head 100 may be formed of high-strength materials (e.g., metal) to support the heavy load.

In use, the gripper head 100 with the gripped load may be moved from one location to another. For example, the gripper head 100 may pick up the load from a first surface (e.g., a pallet) and carry the load to a second surface (e.g., an ultrasonic tank; the gripper head 100 may move the load to the ultrasonic tank and lower the load into the tank).

The gripper head 100 may be configured to pick up a load having any outer diameter between about 10 cm to about 100 cm. Accordingly, the tracks 130 extend out from the vertical axis 120 by an amount sufficient to grasp such an item, either by grasping the perimeter or by gripping an interior surface surrounding an aperture. In some examples, the tracks 130 have a length between about 5 cm and about 60 cm, between about 5 cm and about 50 cm, between about 10 cm and about 50 cm, or between about 20 cm and about 40 cm.

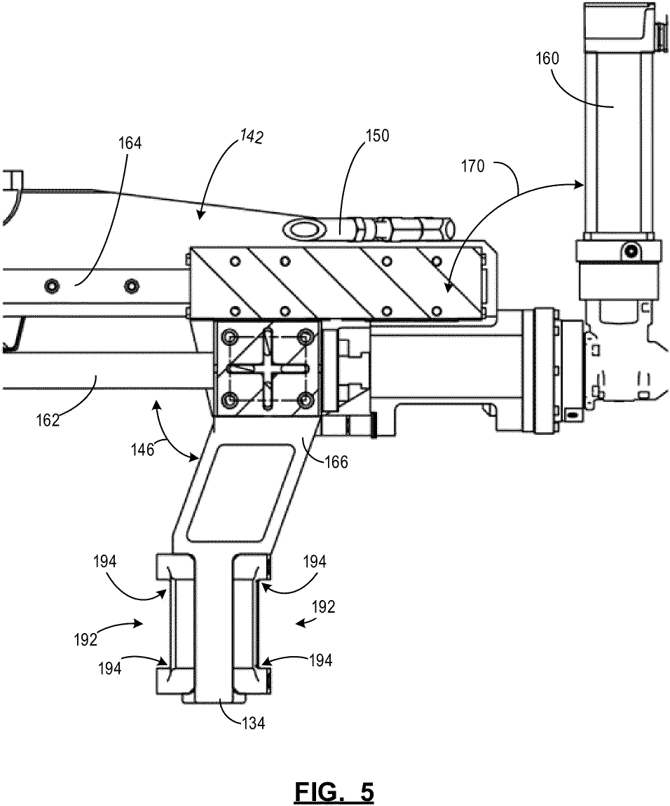

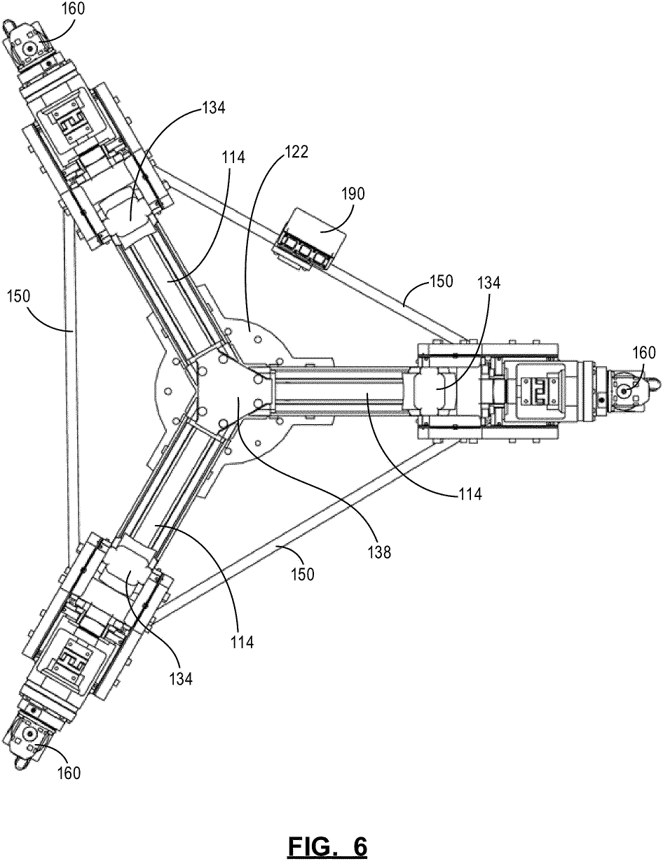

Referring now to FIGS. 3 to 5, while the gripper fingers 134 may be moved in various ways (e.g., linear rams, drive belts, etc.), in some examples the gripper head 100 includes a plurality of drive units 160. Each gripper finger 134 is coupled to a corresponding drive unit 160 to be moved by the drive unit.

Each drive unit 160 is associated with a track 130 to move the gripper finger 134 supported by the track 130. The track 130 of the illustrated example includes a ball screw 162 and a linear rail 164. Each gripping finger 134 is mounted to a rail 164 to move along the rail 164. The gripper finger 134 includes a mount 166. The mount includes a ball nut. The drive unit 160 associated with the track 130 may rotate the ball screw 162 to move the gripper finger 134 along the rail 164.

While the drive units 160 may be arranged in any suitable way, in some examples the drive unit 160 is secured to the frame 110 at the second end 142 of the associated track 130. Positioning the drive unit 160 at the second end 142 of the associated track 130 may reduce number of components adjacent the vertical axis 120. The drive units 160 may be spaced from the vertical axis 120, the mounting point for the arm of a robot, and/or the palm plate 138 (e.g., by at least the track length). In some examples, a drive unit 160 (e.g., each drive unit 160) extends upwards at a drive unit angle 170 of at least 30 degrees, at last 45 degrees or about 90 degrees to the common plane in which each of the plurality of tracks 130 extends. This may reduce the diameter of the gripper head 100.

In some examples, the gripper fingers 134 are each force-sensing fingers. The gripper head 100 may be configured to sense a force, such as a force applied to a load by the gripper fingers 134. In some examples, the drive units 160 are servo drive units, and the encoder values of the servo drive units are used to determine a force associated with the gripper fingers 134.

Each gripper finger 134 includes a gripping surface 180. The gripping surface 180 is arranged on the gripping finger 134 to bear against a load between or around the gripping fingers 134 when the gripping finger 134 is moved along the track 130. The gripping surface 180 may include a concave shape 192 and/or one or more internal corner 194 to facilitate holding a load.

The gripper head 100 may apply a predetermined torque matched to the size and/or weight of a load. The gripper head 100 may monitor the rotations of the ball screw system to determine if the pads forming the gripping surfaces 180 are worn out or damaged. The gripper head 100 can also monitor the drive units 160 of each cantilever arm 114 to determining if they are able to make the required torque (e.g., looking at encoder values on servo drive units).

The gripping surface may be configured to grip the load securely. The load may be supported fully by the gripping fingers, without resting on any plate or other surface, and so the gripping surfaces may be high-friction surfaces. The gripping surfaces may also need to hold the load in a wet environment (e.g., when placing the load in a water tank or lifting the load out of the water tank). The gripping surface may be a surface of a pad or coating secured to a body of the gripping finger. For example, the gripping surface may be a surface of a pad made with fiberglass and epoxy (e.g., a Garolite™ pad). As exemplified, in some examples each gripper finger 134 includes a first gripping surface 182 directed towards the vertical axis 120 and a second gripping surface 184 directed away from the vertical axis 120. First and second gripping surfaces 182, 184 may allow the gripping finger 136 to be used to hold either an outside perimeter of a load or an inside surface surrounding a central aperture.

While each gripper finger 134 could be operable independently in some examples, moving the gripper fingers 134 at the same time and/or by the same amount (e.g., synchronistic movement) may allow for better gripping performance. For example, synchronistic movement may allow a load to be centered more easily. In some examples, the gripper fingers 134 are operable to be moved synchronistically.

Referring now to FIG. 6, in some examples the gripper head 100 includes additional hardware (i.e., accessory devices). The support bars 150 may be configured as mounting locations for the accessory devices. As exemplified, a camera 190 or other accessory device may be mounted on a support bar 150.

The present invention has been described here by way of example only. Various modification and variations may be made to these exemplary embodiments without departing from the scope of the invention, which is limited only by the appended claims.

1. A gripper head, comprising:
a. a frame having a plurality of cantilever arms, an upper end, and a lower end opposite the upper end, with a vertical axis extending between the upper end and the lower end;
b. a plurality of discrete and spaced-apart tracks, each track extending out from the vertical axis and supporting a gripper finger operable to move along the track between a first position and a second position, the second position being farther from the vertical axis than the first position, each track supported by a corresponding cantilever arm of the plurality of cantilever arms, and
c. a plurality of support bars, each support bar extending between two cantilever arms of the plurality of cantilever arms.

2. The gripper head of claim 1, wherein each track includes a first end adjacent the vertical axis and a second end opposite the first end, the second end being farther from the vertical axis than the first end.

. 3. The gripper head of claim 1, wherein each track extends perpendicular to the vertical axis.

4. The gripper head of claim 1, wherein the plurality of tracks extend in a common plane.

5. The gripper head of claim 1, wherein the tracks are equally spaced about the vertical axis.

6. The gripper head of claim 1, wherein the first and second positions are radially spaced from the vertical axis, and the gripper head is configured as a chuck to hold a load gripped by the gripper fingers.

7. The gripper head of claim 1, wherein the gripper fingers are operable to be moved synchronistically.

8. The gripper head of claim 1, further comprising a plurality of drive units, wherein each gripper finger is coupled to a corresponding drive unit of the plurality of drive units to be moved by the drive unit.

9. The gripper head of claim 8, wherein each drive unit is associated with a track of the plurality of tracks, and the drive unit is secured to the frame at the second end of the associated track.

10. The gripper head of claim 9, wherein each drive unit extends upwards at an angle of at least 45 degrees to the common plane in which each of the plurality of tracks extends.

11. The gripper head of claim 10, wherein the gripper fingers each extend downward at an angle of at least 45 degrees to the common plane in each of the first and second positions.

12. The gripper head of claim 1, wherein each track of the plurality of tracks includes a rail and the gripping finger is mounted to the rail to move along the rail.

13. The gripper head of claim 1, wherein each track of the plurality of tracks is a linear track.

14. The gripper head of claim 1, wherein each track of the plurality of tracks includes a ball screw.

15. The gripper head of claim 1, wherein each gripper finger is a force sensing finger.

16. The gripper head of claim 1, further comprising a camera mounted on a support bar of the plurality of support bars.

17. The gripper head of claim 1, wherein each support bar extends between the two cantilever arms from the second end of the track of a first of the two cantilever arms to the second end of the track of the second of the two cantilever arms.

18. The pallet of claim 1, wherein each gripper finger includes a gripping surface.

19. The pallet of claim 1, wherein each gripper finger includes a first gripping surface directed towards the vertical axis and a second gripping surface directed away from the vertical axis.

20. The pallet of claim 1, wherein the plurality of tracks is three tracks.
